(19) United States
(12) Patent Application Publication
(10) Pub. No.: US 2012/0275038 A1
(43) Pub. Date: Nov. 1, 2012

(54) Optical Pointing Mechanism

(75) Inventor: Michael R. Hughes, Mason, NH (US)

(73) Assignee: FLIR Systems, Inc., Wilsonville, OR (US)

(21) Appl. No.: 13/095,459

(22) Filed: Apr. 27, 2011

(51) Int. Cl. G02B 7/00

(52) U.S. Cl. 359/811

(57) ABSTRACT

An adjustment mechanism for an optical system is provided. Two concentric eccentric rings support a back end of an optical element. The movements of the two rings relative to each other re-position the back end to affect the orientation of the field of view of the optical element. A clamp ring is provided to fix the position of the back end after the adjustment is completed.

### FIELD OF THE INVENTION

This invention generally relates a pointing or aiming mechanism for optical elements, such as laser pointers, binoculars, telescopes, microscopes, etc.

### BACKGROUND OF THE INVENTION

Optical elements, such as lenses and pointers, mounted within rigid structures, such as gimbals, telescopes, reconnaissance scopes, or the likes, need to have their aiming mechanisms adjusted from time to time. Conventional adjustment devices are disclosed in U.S. Pat. Nos. 2,946,126, 4,497,548 and 5,433,010, among others. One conventional adjustment system disclosed in “Introduction to Opto-Mechanical Design” by Daniel Vukobratovich presented at the 1986 Tufts/SPIE Engineering Update Series in Electro-Optics in Tucson, Ariz., uses two coaxial eccentric rings surrounding an optical lens at the front of optical elements to adjust the position of the lens in two directions, i.e., up-down and side-to-side. However, in applications where space available for the optics is limited, having the positioning or adjustment system at the front end is impractical.

Hence, the remains a need in the art for using adjustment systems, such as coaxial eccentric rings, at locations away from the lenses or the front end of the optical elements.

### SUMMARY OF THE INVENTION

Hence, the invention is directed to an adjustment mechanism for an optical system. The adjustment mechanism comprises two concentric eccentric rings supporting a back end of an optical element. The movements of the two rings relative to each other re-position the back end to affect the orientation of the field of view of the optical element. A clamp ring is provided to fix the position of the back end after the adjustment is completed.

### BRIEF DESCRIPTION OF THE DRAWINGS

In the accompanying drawings, which form a part of the specification and are to be read in conjunction therewith and in which like reference numerals are used to indicate like parts in the various views:

FIG. 1 is a cross-sectional view of an embodiment of an inventive optical pointing mechanism;

FIG. 2A is a perspective rear view and FIG. 2B is a perspective front view of the mechanism shown in FIG. 1; and

FIG. 3 is a schematic rear view of the adjustment mechanism according to the present invention.

### DETAILED DESCRIPTION OF THE PREFERRED EMBODIMENTS

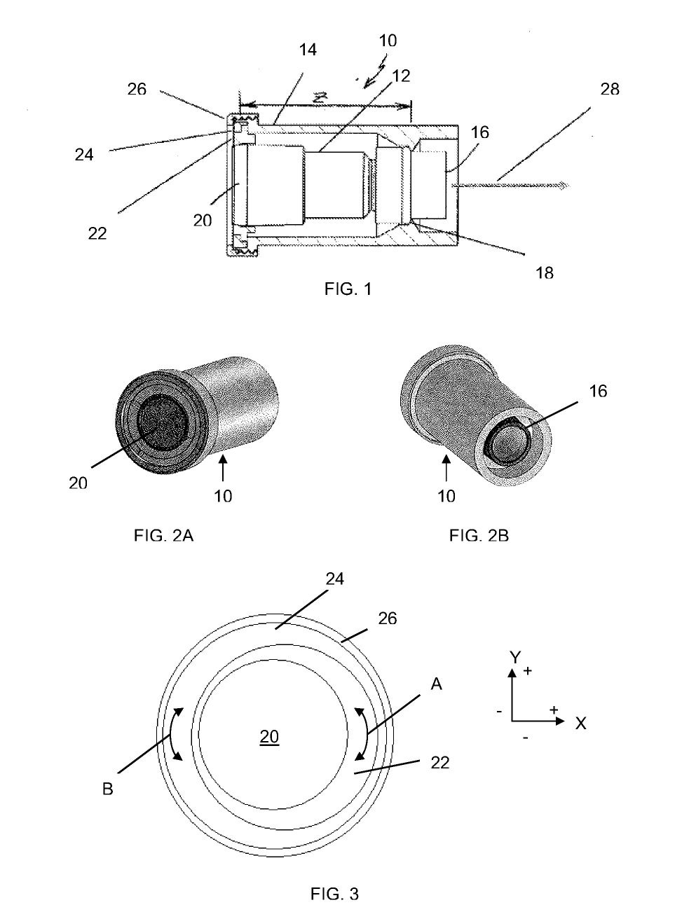

Referring to FIGS. 1, 2A and 2B, optical system or device 10 includes an optical element 12, such as a laser pointer, reconnaissance scope, binocular, telescope or microscopes, is positioned within a housing 14. Front end 16 of optical element 12 is supported for rotational movement by joint 18. Examples of suitable joint 18 include, but are not limited to a spherical interface, a ball-and-socket joint or a shoulder joint. Back end 20 of optical element 12 is supported by an adjustment mechanism comprising an inner eccentric ring 22 and an outer eccentric ring 24. Both eccentric rings are positioned within clamp ring 26.

Rotating inner ring 22 along arrow A and/or rotating outer ring 24 along arrow B move back end 20 in the X-Y plane shown in FIG. 3, and in turn move field of view (FOV) 28 to the desired direction. The operation of the adjustment mechanism is illustrated in FIG. 3. In one example, rotating inner ring 22 about half a revolution along arrow A while holding outer ring 24 stationary would move back end 20 in the X+ direction, i.e., to the right, and the thickest portions of both rings would be adjacent to each other on the left side. This X+ movement of back end 20 moves FOV 28 in the X− direction, i.e., to the left. Rotating outer ring 24 half a revolution along arrow B while holding inner ring 22 stationary would move back end 20 in the X− direction, i.e., to the left, and the thickest portions of both rings would be adjacent to each other on the right side. This X− movement of back end 20 moves FOV 28 in the X+ direction.

Similarly, when both rings are rotated so that their thickest portions are located on top in reference to FIG. 3, back end 20 would move downward in the Y− direction and FOV 28 would move upward in the Y+ direction. Likewise, when both rings are rotated so that their thickest portions are located on the bottom in reference to FIG. 3, back end 20 would move upward in the Y+ direction and FOV 28 would move downward in the Y− direction. Moreover, the thickest (or thinnest) portions of both rings can be positioned at any angular position in the X-Y plane unaligned to either the X-axis or the Y-axis to point FOV 28 in any desirable direction. Additionally, the thickest (or thinnest) portions of both rings don't have to be positioned adjacent to each other. The alignment of the thickest (or thinnest) portions relative to each other affects the amount of displacement of back end 20 and FOV 28 on the X-Y plane.

Preferably, back end 20 is loose within inner ring 22. With the clamp ring 26 loosened, inner ring 22 becomes unloaded relative to back end 20, reducing any friction forces between the inner ring and the back end, allowing one to be positioned relative to the other. Ideally, clamp ring 26 is loosened just enough to allow inner ring 22 to slide on or relative to back end 20 without losing contact. After the FOV 28 is aligned to the correct orientation, clamp ring 26 is tightened, which increases a normal force imparted by inner ring 22 on back end 20. That normal force causes sufficient friction between inner ring 22 and back end 20 to prevent any further relative motion, thereby holding the orientation of back end 20.

Another parameter that can control the angle or cone of rotation of FOV 28 is the distance Z between joint 18 and inner/outer concentric rings 22 and 24. Since optical element 12 is substantially pivoted at joint 18 and moved at back end 20, shorter distance Z allows the cone of rotation to be larger and longer distance Z minimizes the size of the cone of rotation about pivot/joint 18.

Clamp ring 26 is provided to maintain the position of back end 20. When clamp ring 26 is tightened, e.g., by rotating in the clockwise direction, movements of rings 22 and 24 are prohibited to lock in the position of back end 20 and FOV 28. When clamp ring is loosened, e.g., by rotating in the counter-clockwise direction, movements of rings 22 and 24 are allowed to adjust the position of back end 20 and FOV 28.

Advantages of the present invention over the prior art include, but are not limited to, situations where space inside housing 14 is limited. One application is military reconnaissance equipment such as visual or IR scopes, where the housing needs to be small, lightweight and compact. An operator can adjust FOV 28 by manipulating clamp ring 26 and eccentric rings 22 and 24, which are conveniently located near the operator's hands and eyes to minimize the movements of the operator's hands. Another application for the inventive adjustment mechanism is for optical elements mounted to rotating gimbals. In most gimbals, the front ends of the optical elements when installed on the outer housing of the gimbals generally cannot be moved translationally; however, the back ends can be moved rotationally. The inventive adjustment mechanism can be used in such situation to adjust the FOV of the optical elements.

While it is apparent that the illustrative embodiments of the invention disclosed herein fulfill the objectives stated above, it is appreciated that numerous modifications and other embodiments may be devised by those skilled in the art. Therefore, it will be understood that the appended claims are intended to cover all such modifications and embodiments, which would come within the spirit and scope of the present invention.

I claim:

1. An optical device comprising an optical element having a front end and a back end disposed in a housing, wherein the front end is supported for rotational movement by the housing and wherein the back end is supported by an adjustment mechanism, said adjustment mechanism comprises:
an inner eccentric ring disposed within an outer eccentric ring wherein the back end is positioned within the inner eccentric ring and wherein the inner eccentric ring, the outer concentric ring are movable relative to each other to adjust the position of the back end, and
a clamp ring to fix the position of the back end.

2. The optical device of claim 1, wherein the back end is movable relative to the inner eccentric ring during adjustment.

3. The optical device of claim 1, wherein the clamp ring is rotatable in one direction to allow the inner and outer eccentric rings to move relative to each other and is rotatable in the opposite direction to prevent the inner and outer eccentric rings from moving relative to each other.

4. The optical device of claim 1, wherein the front end is supported by a spherical interface on the housing.
